(19) United States
(12) Patent Application Publication
(10) Pub. No.: US 2025/0000053 A1
(43) Pub. Date: Jan. 2, 2025

(54) ANIMAL ENCLOSURE WITH REMOVABLY COUPLED BREEDER OR LITTER BOX ASSEMBLY

(71) Applicant: Mid-West Metal Products Company, Inc., Muncie, IN (US)

(72) Inventors: Brad CANTWELL, Muncie, IN (US); Michael E. GREENE, Muncie, IN (US)

(21) Appl. No.: 18/693,243

(22) PCT Filed: Sep. 21, 2022
(86) PCT No.: PCT/US2022/044188

§ 371 Date: Mar. 19, 2024

Related U.S. Application Data
(60) Provisional application No. 63/247,021, filed on Sep. 22, 2021.

(51) Int. Cl. A01K 1/03; A01K 1/01

(52) U.S. Cl. CPC A01K 1/032; A01K 1/0125

(57) ABSTRACT

An animal enclosure includes a plurality of members defining an interior of the enclosure. The plurality of members include a first member having a plurality of interconnected horizontal and vertical wires that define a first opening configured to provide access to the interior. The enclosure includes a support frame having a top member, a bottom member, a first side member, and a second side member. The support frame defines a second opening between the top member and the bottom member. A box assembly includes a top, a bottom, a front, a first side, and a second side. The box assembly defines a third opening for accessing an interior thereof. The first member, the support frame, and the box assembly are coupled such that the first opening, the second opening, and the third opening are aligned with one another.

### FIELD OF THE DISCLOSURE

This application is a 371 application claiming priority to International Application PCT/US2022/044188, filed Sep. 21, 2022, which claims the benefit of U.S. Provisional Patent Application Ser. No. 63/247,021, filed Sep. 22, 2021, the disclosures of which are hereby incorporated by reference in its entirety.

### FIELD OF THE DISCLOSURE

The present disclosure relates to an animal enclosure assembly, and in particular to an animal enclosure assembly with a breeder or litter box assembly removably coupled thereto.

### BACKGROUND

The use of animal cages is well known in the prior art. Many conventional cages have been developed over the years for housing animals of different sizes, and through the development of these cages flexibility and portability have become points of emphasis. Some conventional cages, for example, have been designed to collapse to a compact position for portability. Others have been designed of light weight and from durable materials. Conventional cages have been designed for ease of transporting an animal.

Most conventional cages include at least one door for providing access to the interior of the cage. An animal can enter or exit the cage through the opening when the door is opened, and the animal can be safely contained in the cage when the door is closed. Many conventional cages include a door that is attached to the cage via a hinge. This allows the door to be swung open and closed. A spring activated latch or the like have been incorporated into the design of the door to allow a user to open or lock the door.

Many of these conventional designs have limitations, however. For instance, many conventional cages are limited to solely housing an animal for a period of time. Other enclosures may be necessary for breeding or for housing litters.

Thus, there is a need for an animal enclosure assembly capable of being coupled to a breeder or litter box assembly.

### SUMMARY

In one embodiment of the present disclosure, an animal enclosure includes a plurality of members defining an interior of the enclosure, wherein the plurality of members comprises a first member having a plurality of interconnected horizontal and vertical wires that define a first opening configured to provide access to the interior; a support frame comprising a top member, a bottom member, a first side member, and a second side member, the support frame defining a second opening between the top member and the bottom member; and a box assembly comprising a top, a bottom, a front, a first side, and a second side, the box assembly defining a third opening for accessing an interior thereof; wherein, the first member, the support frame, and the box assembly are coupled to one another; wherein, the first opening, the second opening, and the third opening are aligned with one another for coupling the interior of the enclosure with the interior of the box assembly.

In one example of this embodiment, a back of the box assembly is entirely open. In a second example, the box assembly is formed by a plurality of interconnecting wires. In a third example, the box assembly comprises an elongate wire for coupling the top and front to one another. In a fourth example, the elongate wire is removably coupled to the top and front; wherein, upon removing the elongate wire from coupling the top and front, the box assembly is reconfigurable from an upright configuration to a collapsed configuration.

In a fifth example, the support frame is positioned between the first member and the box assembly. In a sixth example, the support frame comprises a first intermediate member and a second intermediate member, wherein the first intermediate member and second intermediate member are coupled between the top member and bottom member. In a seventh example, the first intermediate member and second intermediate member are spaced inwardly from the first side member and second side member, respectively. In an eighth example, the second opening is defined by the top member, bottom member, the first intermediate member and the second intermediate member.

In a ninth example, the support frame includes a first width and the box assembly comprises a second width, the first width being greater than the second width. In a tenth example, the box assembly comprises a first door and a second door, the first door configured to provide direct access to the interior of the box assembly. In an eleventh example, the second door defines a fourth opening; wherein, the fourth opening is aligned with the first opening, second opening and third opening. In a twelfth example, the fourth opening is smaller than the first opening, second opening and third opening.

In another example, the first side of the box assembly comprises a first cutout portion and a second cutout portion; wherein, the top member of the support frame is positioned within the first cutout portion and the bottom member thereof is positioned within the second cutout portion. In a further example, the first cutout portion is formed between the first side and the top, and the second cutout portion is formed between the first side and the bottom. In yet another example, the second side of the box assembly comprises a third cutout portion and a fourth cutout portion, the third cutout portion being formed between the second side and the top, and the fourth cutout portion being formed between the second side and the bottom. In yet a further example, the top member of the support frame is positioned within the first and third cutout portions, and the bottom member is positioned within the second and fourth cutout portions. In still another example, the first door is pivotally coupled to the top.

In another embodiment, a multi-level animal enclosure includes a first enclosure comprising a plurality of members defining an interior of the first enclosure, wherein the plurality of members comprises a first member having a plurality of interconnected horizontal and vertical wires that define a first opening configured to provide access to the interior; a second enclosure comprising a plurality of members defining an interior of the second enclosure, the second enclosure configured to being located above or below the first enclosure; a support frame comprising a top member, a bottom member, a first side member, and a second side member, the support frame defining a second opening between the top member and the bottom member; and a box assembly comprising a top, a bottom, a front, a first side, and a second side, the box assembly defining a third opening for accessing an interior thereof; wherein, the first member, the support frame, and the box assembly are coupled to one another; wherein, the first opening, the second opening, and the third opening are aligned with one another for coupling the interior of the enclosure with the interior of the box assembly.

In a further embodiment of the present disclosure, a portable animal enclosure includes a frame comprising at least one support leg and a rotatable member coupled thereto; a plurality of members defining an interior of the first enclosure, wherein the plurality of members comprises a first member having a plurality of interconnected horizontal and vertical wires that define a first opening configured to provide access to the interior; a support frame comprising a top member, a bottom member, a first side member, and a second side member, the support frame defining a second opening between the top member and the bottom member; and a box assembly comprising a top, a bottom, a front, a first side, and a second side, the box assembly defining a third opening for accessing an interior thereof; wherein, the first member, the support frame, and the box assembly are coupled to one another; wherein, the first opening, the second opening, and the third opening are aligned with one another for coupling the interior of the enclosure with the interior of the box assembly.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a multi-level animal enclosure assembly with a litter box assembly;

FIG. 2 is a perspective view of the litter box assembly of FIG. 1;

FIG. 3 is a partial perspective and exploded view of the litter box assembly of FIG. 1;

FIG. 4 is a perspective view of a portion of the litter box assembly of FIG. 1;

FIG. 5 is a partial perspective and exploded view of the litter box assembly of FIG. 1;

FIG. 6 is another partial perspective and exploded view of the litter box assembly of FIG. 1;

FIG. 7 is a perspective view of the litter box assembly of FIG. 1 in a collapsed position;

FIG. 8 a perspective view of a multi-level animal enclosure assembly with a breeder box assembly;

FIG. 9 is a perspective view of a side panel of the animal enclosure and breeder box assembly of FIG. 8;

FIG. 10 is an exploded perspective view of the side panel and breeder box assembly of FIG. 9; and

FIG. 11 is an exploded perspective view of the breeder box assembly of FIG. 8.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The present disclosure relates to a wire crate in which one or more animals may be enclosed. The wire crate, however, can be used for multiple purposes, one of which is to contain animals. The crate can be made of any size for accommodating an object of any size. In addition, the crate can be made of different materials including aluminium, plastic, and steel.

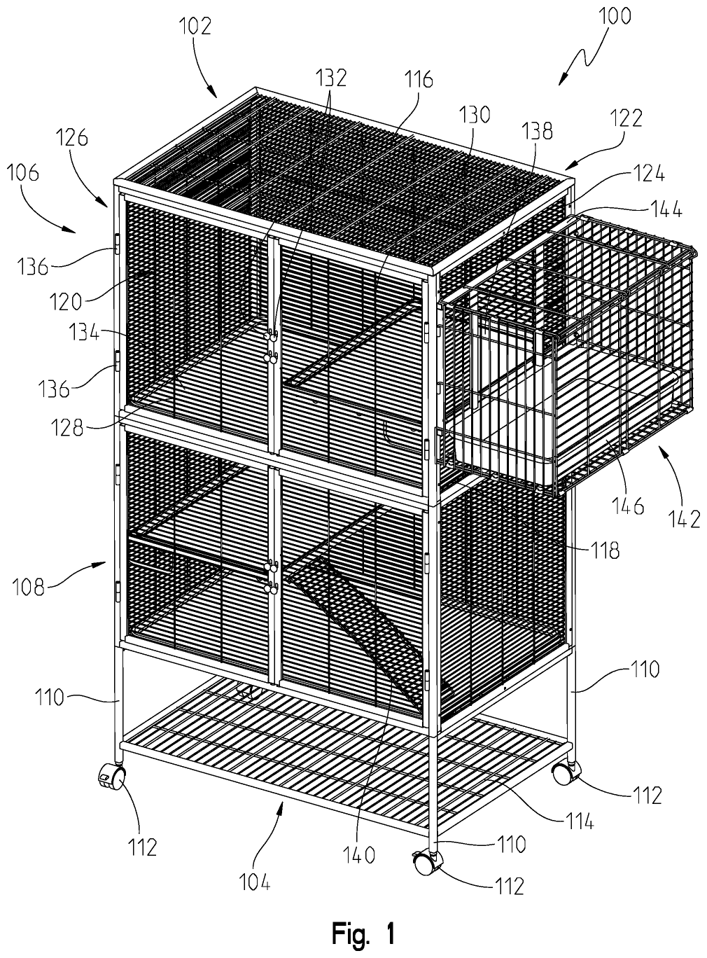

Referring to FIG. 1, one embodiment of an animal enclosure assembly in the form of a multi-level crate assembly 100 of the present disclosure is shown. In this embodiment, the multi-level crate assembly 100 may include a first enclosure 106 and a second enclosure 108. The first enclosure 106 is shown being positioned above or on top of the second enclosure 108. In other embodiments, the assembly 100 may include two or more enclosures. In a different embodiment, the assembly 100 may only include a single enclosure.

As shown in FIG. 1, the multi-level crate assembly 100 has a top portion 102 and a bottom portion 104. At the bottom portion 104, the assembly 100 may include a frame that forms a bottom shelf 114 located below the second enclosure 108. The frame may form a plurality of support legs 110 which are each coupled to a caster 112 or wheel to allow the crate assembly 100 to be transportable.

Referring now to the first enclosure 106, it may be provided with a top panel 116, a bottom panel 118, a front panel 120, a back panel 122, and a pair of side panels oppositely disposed from one another. The pair of side panels includes a first side panel 124 and a second side panel 126. In this embodiment, the front panel 120 can include a first door assembly 128 and a second door assembly 130. Each door assembly may include a latch 132 which is releasable for opening or closing the door assembly. Each of the panels may be formed by a plurality of interconnecting horizontal and vertical wires.

The first and second door assemblies may be pivotally coupled to the front panel 120 via one or more hinges 136. The panels of the first enclosure 106 forms an interior for housing an animal. Within the interior, a bottom pan 134 may be disposed on top of the bottom panel 118. A shelf 138 may optionally be provided. In use, the shelf 138 may be coupled to one of the panels. In FIG. 1, for example, the shelf 138 is coupled to the first side panel 124.

The second enclosure 108 may be similar constructed as the first enclosure 106. Although not shown, a ramp with a plurality of steps may connect the interior of the first enclosure 106 to the interior of the second enclosure 108 so that an animal may traverse the ramp to access both interiors. A ramp 140 is shown in the interior of the second enclosure 108, where the ramp 140 is disposed between the bottom pan and a shelf.

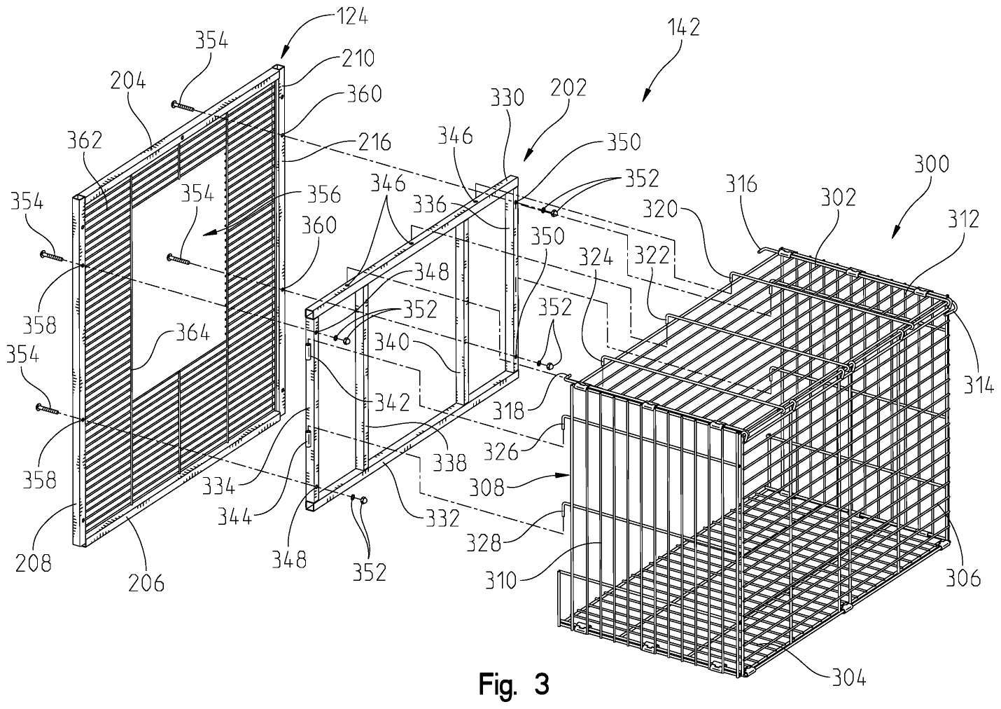

As shown in the embodiment of FIG. 1, a litter box assembly 142 may be coupled to the multi-level crate assembly 100. To achieve the coupling, the first side panel 124 may be designed with an opening 356 (see FIG. 3) for an animal to travel between the crate assembly 100 and the litter box assembly 142. The litter box assembly 142 may include a support frame 144 coupled to the first side panel 124. A pan 146 may be disposed within an interior of the litter box assembly 142 as shown in FIG. 1.

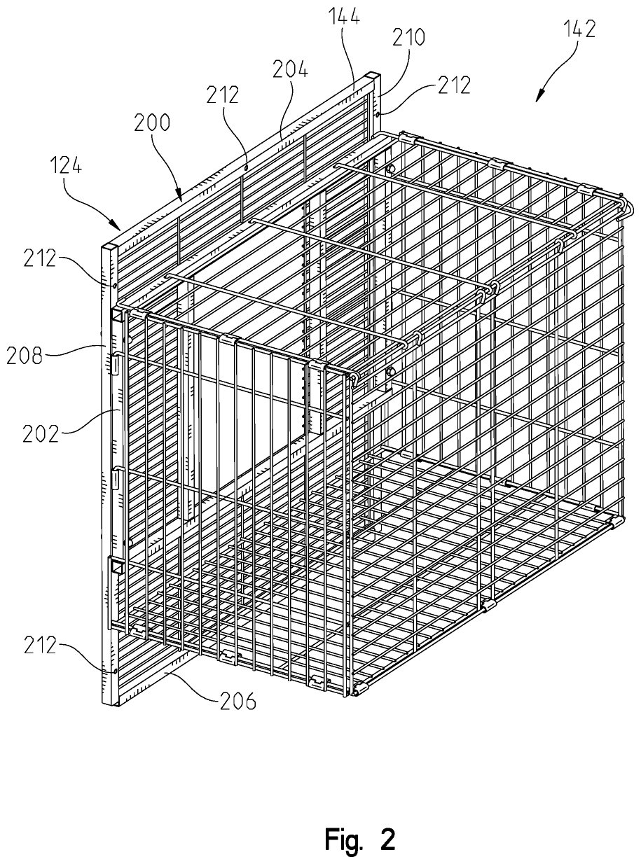

Referring now to FIG. 2, the litter box assembly 142 has been removed from the multi-level crate assembly 100. Here, only the first side panel 124 of the first enclosure 106 is shown being coupled to the litter box assembly 142. The first side panel 124 may include a border panel 200 which is coupled to a support frame 202 of the litter box assembly 142. The border panel 200 may include a top border member 204, a bottom border member 206, a first side border member 208, and a second side border member 210. The various border members may include one or more openings 212 defined therein for coupling to the support frame 202 and/or the litter box assembly 142. Moreover, the border members may include a first face 216 oriented towards the support frame 202 for being coupled thereto in an assembled configuration.

In FIG. 3, for example, the support frame 202 is shown exploded from the first side panel 124 and the litter box assembly 142. Here, the litter box assembly 142 may include a litter box 300 formed by a plurality of interconnecting wires. For instance, the litter box 300 may include a top 302, a bottom 304, a front 306, a back 308, a first side 310 and a second side 312. The back 308 is located proximal to the support frame 202, whereas the front 306 is located distal from the support frame 202. Each of the top, bottom, back, and both sides may be formed by the plurality of interconnecting horizontal and vertical wires. The back 308 is substantially open in the embodiment of FIG. 3. In other embodiments, the back 308 may include at least a portion of interconnecting wires with an opening defined therein. In either case, an opening is formed in the back 308 to allow an animal to travel between the enclosure and the litter box 300.

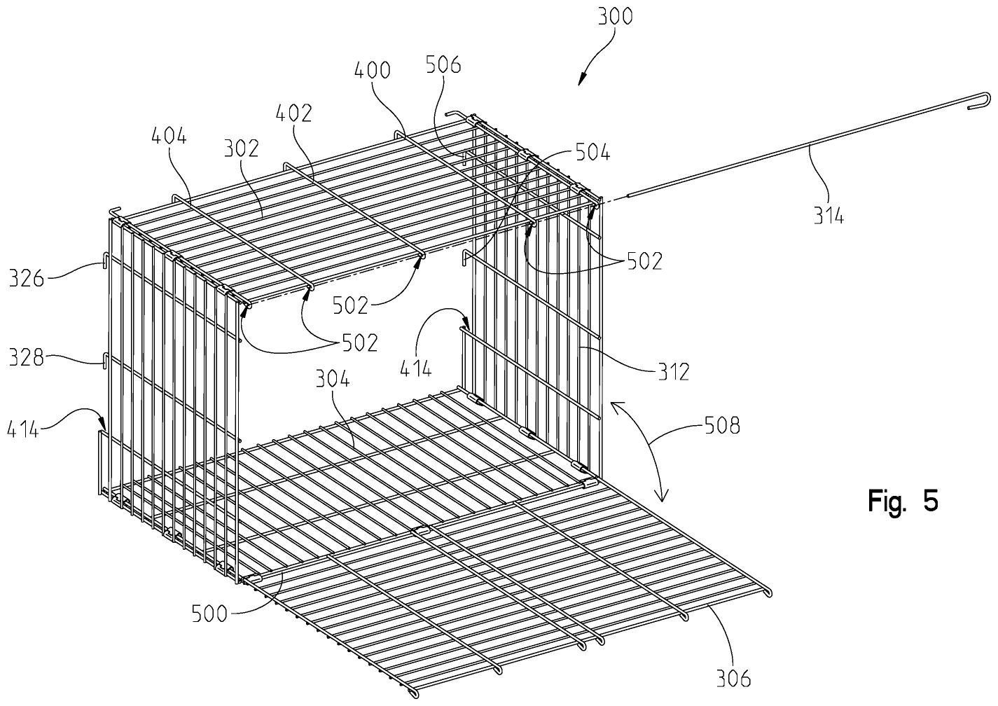

The litter box 300 may be partially held in its deployed or upright configuration via one or more elongated hooks 314. Each elongated hook 314 may pass through clamp brackets or the like between, e.g., the top 302 and first side 310 or second side 312. When the hook 314 is removed, as in FIG. 5, the litter box 300 may be collapsed to a stored position. In FIG. 3, a first elongated hook 314 may include a first end hook 316 and a second elongated hook 314 may include a second end hook 318. The first end hook 316 is located nearest the second side 312, whereas the second end hook 318 is located nearest the first side 310.

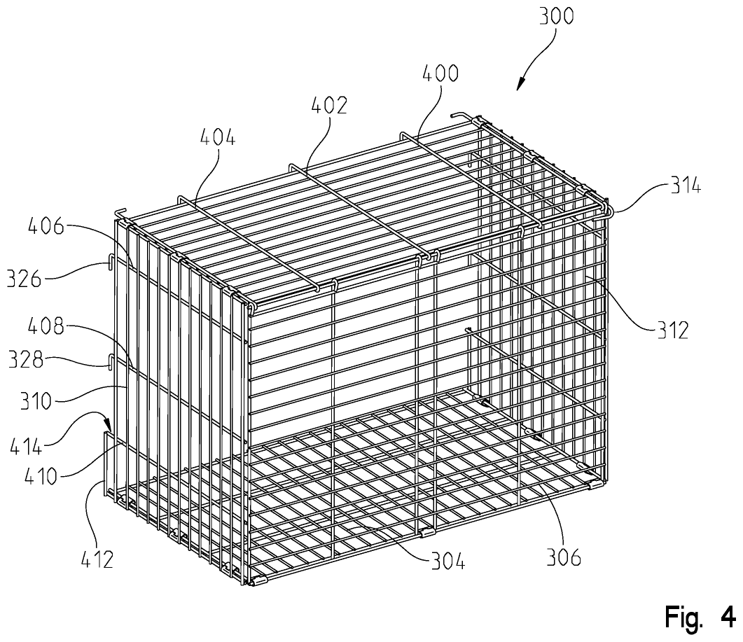

Other wires that form the top 302 may terminate as hooks. For instance, as shown in FIGS. 3 and 4, the top 302 may include a first top horizontal wire 400 forming a first hook 320, a second top horizontal wire 402 forming a second hook 322, and a third top horizontal wire 404 forming a third hook 324. Each of the first, second and third hooks may be spaced from one another as shown in FIG. 3. Similarly, the first side 310 may include a plurality of horizontal wires that terminate into hook ends including a first side horizontal wire 406 forming a fourth hook 326 and a second side horizontal wire 408 forming a fifth hook 328. The second side 312 may also include hooks 504, 506 (see FIG. 5) which, as will be described, may engage with the support frame 202.

The first side 310 may further include a third side horizontal wire 410 as shown in FIG. 4. Here, the third side horizontal wire 410 extends further than the other side horizontal wires and thus is longer than the first and second side horizontal wires. As shown, the third side horizontal wire 410 includes an extended portion 414. Due to this extension, a first side vertical wire 412 may interconnect with the extended portion 414 in a substantially perpendicular manner. In the same way, the second side 312 may include a similar extended portion and corresponding vertical wire. As shown in FIGS. 2 and 3, a bottom member 332 of the support frame 202 may be at least partially disposed below the extended portion 414 of the first and second sides.

Turning to the support frame 202 in FIG. 3, it may be formed by a plurality of members include a top member 330, the bottom member 332, a first side member 334, a second side member 336, a first vertical member 338, and a second vertical member 340. The first and second vertical members are offset from and located internally with respect to the first side member 334 and the second side member 336. The first side member 334, second side member 336, first vertical member 338 and second vertical member 340 may extend between the top member 330 and bottom member 332.

A first sleeve 342 and a second sleeve 344 may be coupled to the first side member 334. Each sleeve may include an opening for receiving the fourth hook 326 and fifth hook 328, respectively. Similarly, the second side member 336 may include one or more sleeves for receiving a hook.

The top member 330 may include one or more holes 346 formed in a top surface thereof. Each hole 346 may be configured to receive one of the first hook 320, second hook 322, and third hook 324.

The first side member 334 may include one or more holes 348 defined therein, and the second side member 336 may include one or more holes 350 defined therein. When coupling the support frame 202 to the first side panel 124, the first holes 348 may be aligned with corresponding holes 358 in the first side panel 124. Likewise, the second holes 350 may be aligned with corresponding holes 360 in the first side panel 124. A plurality of fasteners 352 and bolts 354 may be used to couple the support frame 202 to the first side panel 124.

The first side panel 124 may be formed by a plurality of interconnecting horizontal wires 362 and vertical wires 364. Moreover, an opening 356 may be formed in the first side panel 124 to allow an animal to move therethrough. The opening 356 may also be bounded by the first vertical member 338 and second vertical member 340 when the support frame 202 is coupled to the first side panel 124.

Referring to FIGS. 5-7, a process of collapsing the litter box 300 from its upright position to its collapsed position is shown. In FIG. 5, for example, a first step in collapsing the litter box 300 is for the elongated hook 314 to be removed from the first hook 320, second hook 322, and third hook 324. Each hook may form an opening or eyelet 502 through which the elongated wire 314 is positioned. As the elongated hook 314 is removed, the front member 306 is released from the top member 302, thereby allowing the front member 306 to pivot about a pivot wire 500 in a pivotal direction 508 away from the top member 302 as shown in FIG. 5.

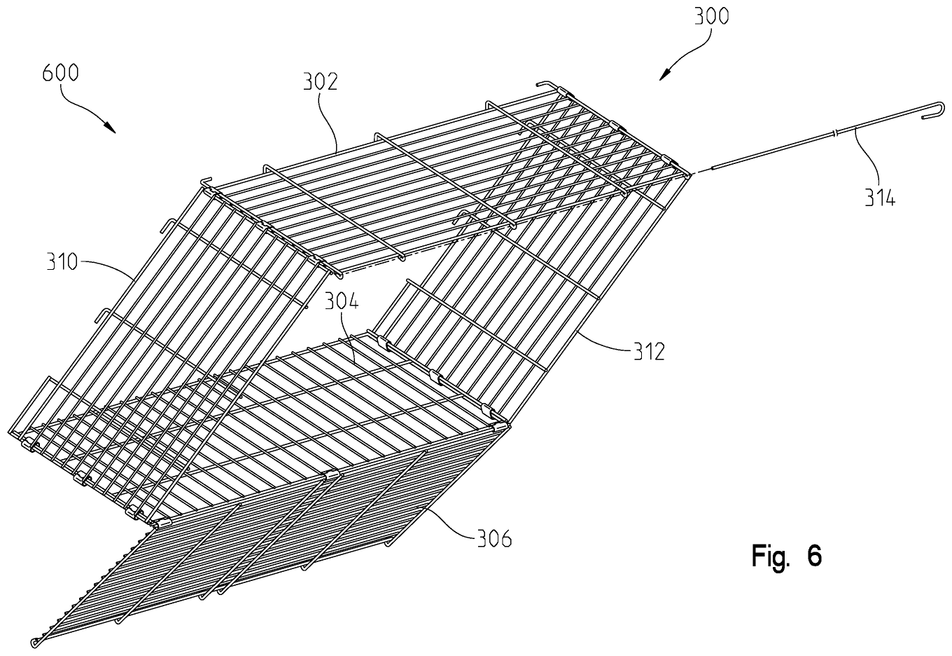

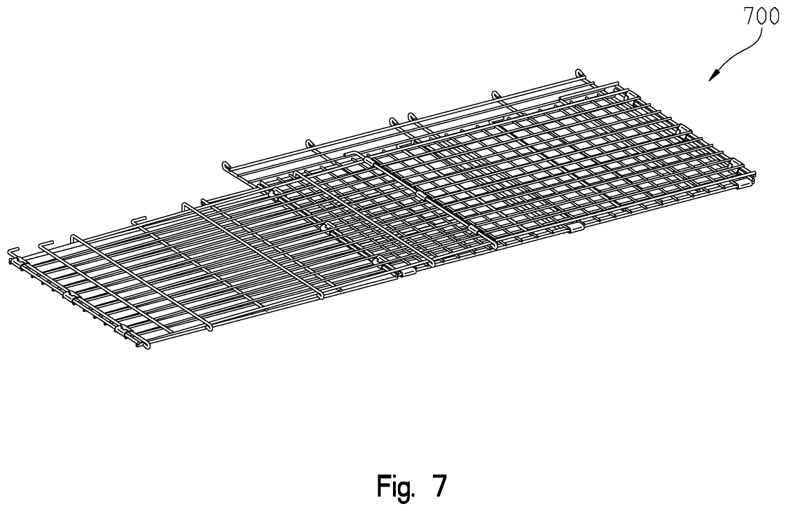

Once the front member 306 is pivoted out of the way, the first side member 310 and second side member 312 may pivot about a pivot wire on the bottom member 304. This is illustratively shown in FIG. 6 as a partially collapsed configuration 600. In doing so, the top member 302 also moves downward simultaneously. The various members may be folded on top of one another as shown in a collapsed position 700 in FIG. 7. For example, the first side member 310 may pivot to be above or over the bottom member 304. The top member 302 may move downwardly and be positioned partially above or over the first side member 310. The front member 306 may be pivoted so that it is located above or over the top member 302.

In some embodiments, the litter box 300 may be coupled to the second side panel or to any panel of the first or second enclosure. In several embodiments, there may be multiple litter boxes 300 coupled to the one or more enclosures. For example, there may be a first litter box 300 coupled to the first enclosure 106 and a second litter box 300 coupled to the second enclosure 108.

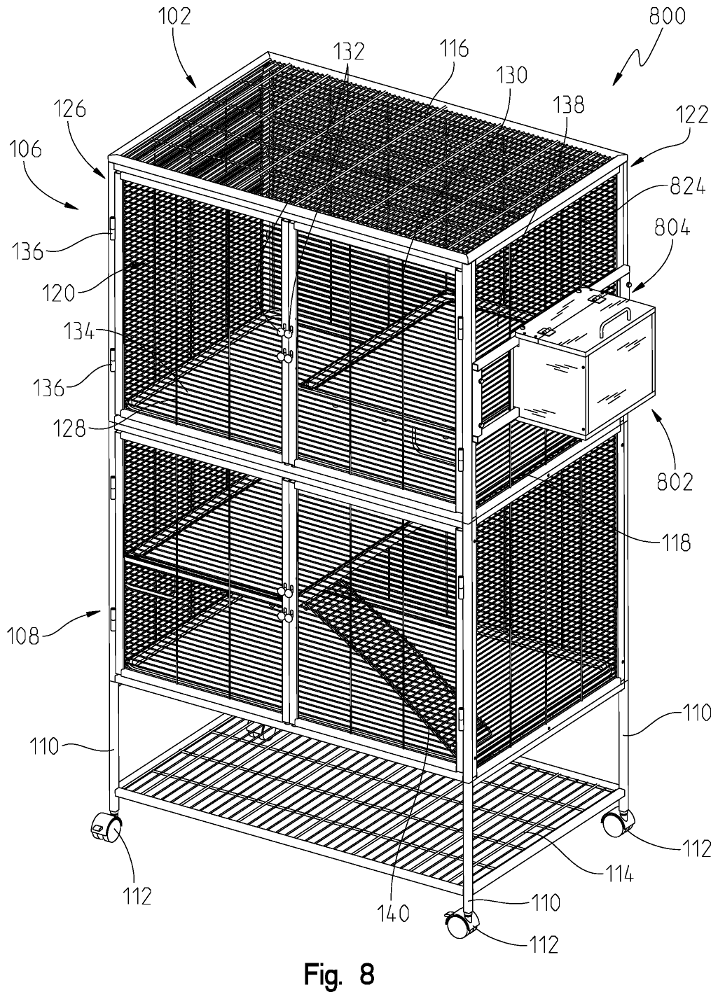

In another embodiment of the present disclosure, a breeder box assembly 802 may be removably coupled to a multi-level or single level enclosure 800. Although multiple levels are shown in FIGS. 1 and 8, it is to be understood that the present disclosure may apply to a single level enclosure or to a multi-level enclosure. The enclosure assembly 800 may include the breeder box assembly 802, a support frame assembly 804 and a side panel 824. The side panel 824 may replace the side panel 124 of FIG. 1, whereas the other portions of the first enclosure 106 and/or second enclosure 108 remain the same.

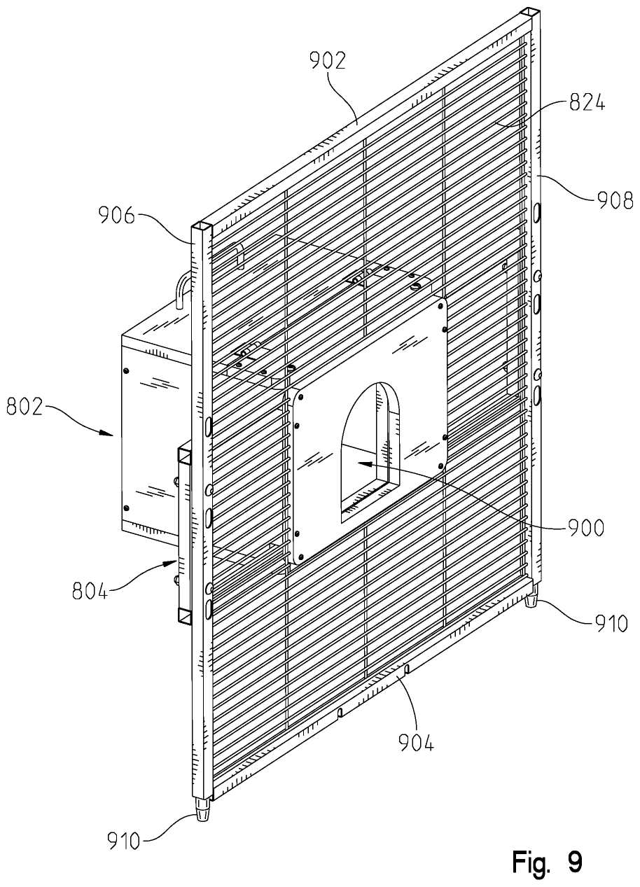

Referring to FIGS. 9-11, the side panel 824, breeder box assembly 802 and support frame assembly 804 are shown in greater detail. In FIG. 9, a view is shown from inside the enclosure facing towards the breeder box assembly 802. As shown, the side panel 824 may comprise a top border member 902, a bottom border member 904, a first side border member 906, and a second side border member 908. A pair of pegs 910 may protrude downwardly from the first and second side border members 906, 908, respectively. The pegs 910 may be configured to engage an opening formed in another panel of the enclosure assembly 800.

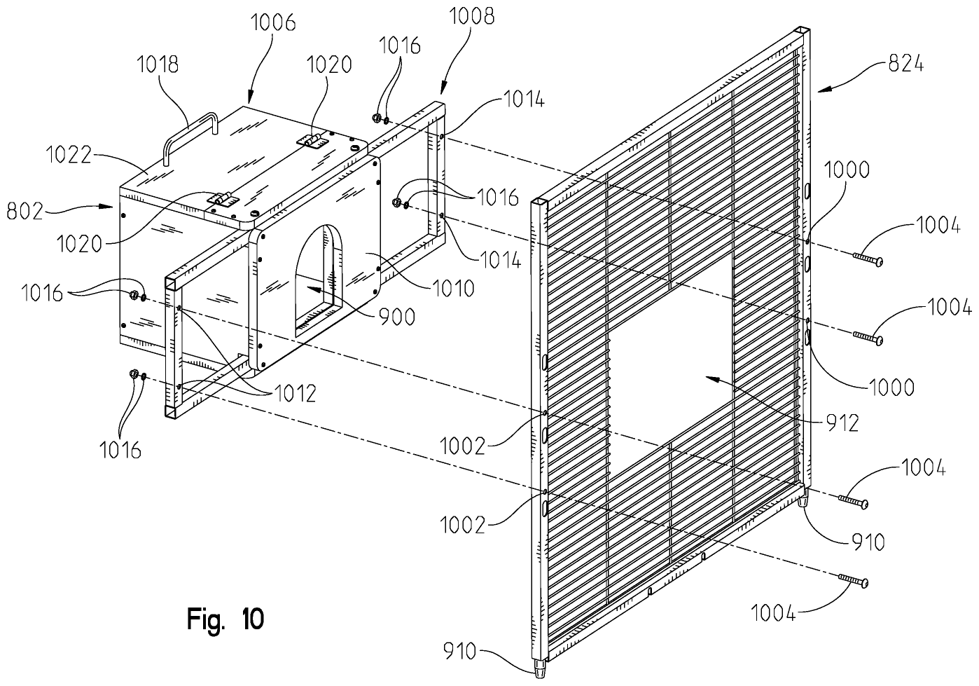

As also shown in FIG. 9, the support frame assembly 804 may include a defined opening 912 which allows an animal to travel between the interior of the enclosure assembly 800 (e.g., the first enclosure 906 or a second enclosure) and an interior of the breeder box assembly 802. To do so, the side panel 824 also includes an opening 912 that aligns with the corresponding opening 900 in the support frame assembly 804 (see FIG. 10).

Referring now to FIG. 10, the side panel 824 is shown separated from the breeder box assembly 802 and support frame assembly 804. The side panel 824 may include a plurality of holes 1000 formed in the second side border member 908 and a plurality of holes 1002 formed in the first side border member 906. In the same way, the support frame assembly 804 may include a first plurality of holes 1012 and a second plurality of holes 1014 formed therein. When the support frame member 804 is aligned for coupling to the side panel 824, the plurality of holes 1000 and second plurality of holes 1014 may be aligned, and the plurality of holes 1002 and first plurality of holes 1012 may be aligned. Bolts 1004 and/or other fasteners 1016 may be used to couple the side panel 824 and support frame assembly 804 to one another.

In FIG. 10, the breeder box assembly 802 and support frame assembly 804 may be coupled to form a single assembly. Here, a breeder box body 1006 may be coupled to a support frame 1008, which is further coupled to a door 1010. The door 1010 may define the opening 900 as previously described. The breeder box body 1006 may include an access door 1022 at its upper or top end. In some embodiments, access may be achieved at other locations on the breeder box body 1006. Access to an interior of the breeder box body 1006 may be achieved by lifting on a handle 1018 which is affixed to the access door 1022. As the handle 1018 is lifted, the access door 1022 may pivot about one or more hinges 1020 relative to the breeder box body 1006.

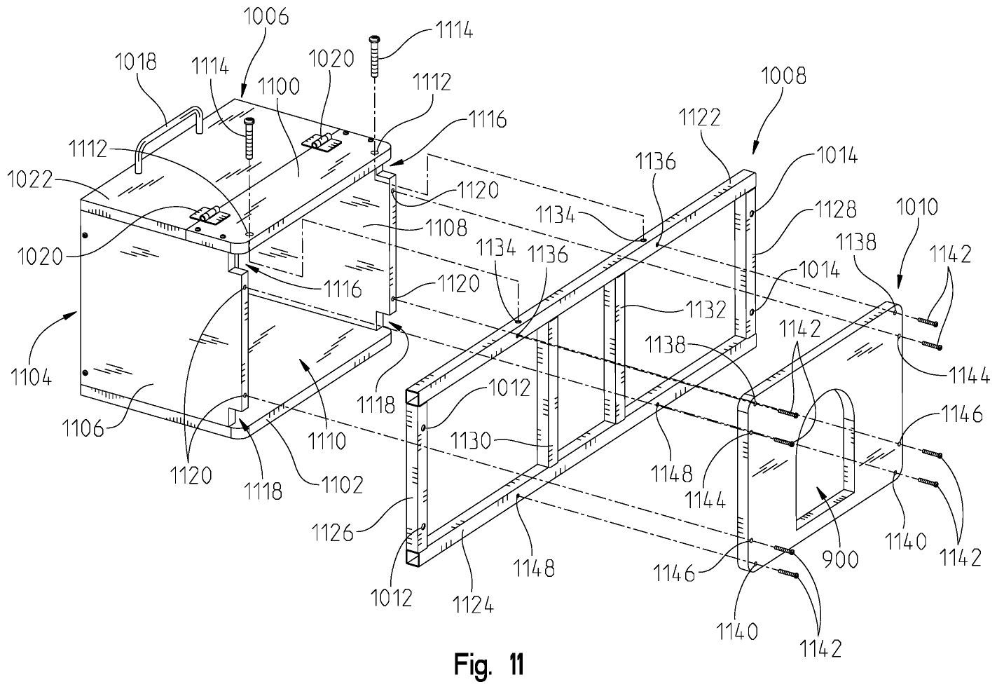

The details of the breeder box body 1006, support frame 1008 and door 1010 are shown in FIG. 11. The breeder box body 1006, for example, may include a top 1100, a bottom 1102, a front 1104, a first side 1106, and a second side 1108. The access door 1022 may be pivotally coupled to the top 1100. In another embodiment, the access door 1022 may be pivotally coupled to the front 1104, first side 1106 or second side 1108. The top 1100, bottom 1102, front 1104, first side 1106, and second side 1108 define an interior 1110 as shown.

The support frame 1008 may be formed by a plurality of members. For example, the frame 1008 may include a frame top 1122, a frame bottom 1124, a frame first side 1126, and a frame second side 1128. A frame first intermediate member 1130 and a frame second intermediate member 1132 may be vertically oriented and coupled between the frame top 1122 and frame bottom 1124. The pair of intermediate members are spaced from one another by a distance at least as great as a width of the opening 900 formed in the door 1010. In other words, the width of door 1010 is a minimum distance by which the intermediate members 1130, 1132 are spaced.

The support frame 1008 may be coupled to the breeder box body 1006 by locating the frame top 1122 within a top cutout portion 1116 defined between the top 1100 and first side 1106. A similar top cutout portion 1116 may also be defined between the top 1100 and second side 1108. The top cutout portion 1116 may be sized to generally correspond with the corresponding height and width of the frame top 1122.

Similarly, the frame bottom 1124 may be disposed within a bottom cutout portion 1118 which is defined between the bottom 1102 and the first side 1106. A second bottom cutout portion 1118 may be defined between the bottom 1102 and the second side 1108.

The top 1100 may include a plurality of holes 1112 defined therein. Similarly, the frame top 1122 may include a plurality of holes 1134 defined therein. When coupling the breeder box body 1006 and the support frame 1008, the plurality of holes 1112, 1134 may be aligned such that a bolt, screw or other fastener 1114 may be coupled therethrough. In the embodiment of FIG. 11, similar holes are not provided for in the bottom 1102 and frame bottom 1124. However, in other embodiments, there may be holes provided in both and a corresponding fastener may be used to further couple the breeder box body 1006 and support frame 1008 to one another.

To further couple the breeder box body 1006, support frame 1008, and door 1010 to one another, a plurality of holes and fasteners may be used. For example, the first side 1106 and second side 1108 of the breeder box body 1006 may include a plurality of openings 1120. The frame top 1122 may include a plurality of openings 1136 and the frame bottom 1124 may include a plurality of openings 1148, as shown. In the same way, the door 1010 may include multiple sets of openings. As shown in FIG. 11, the door 1010 may include a first plurality of openings 1138, a second plurality of openings 1140, a third plurality of openings 1144, and a fourth plurality of openings 1146. A plurality of fasteners 1142 may be used for coupling the breeder box body 1006, support frame 1008, and door 1010 to one another.

For example, fasteners 1142 may pass through the plurality of openings 1120 in the first and second sides 1106, 1108 of the breeder box body 1006 and the third plurality of openings 1144 in the door 1010, and fasteners 1142 may pass through the plurality of openings 1120 in the first and second sides 1106, 1108 of the breeder box body 1006 and the fourth plurality of openings 1146 in the door 1010 for coupling the breeder box body 1006 and door 1010 to one another. In addition, fasteners 142 may pass through the openings 1136 in the frame top 1122 and the first plurality of openings 1138 of the door, and fasteners 142 may pass through the openings 1148 in the frame bottom 1124 and the second plurality of openings 1140 in the door for coupling the support frame 1008 and door 1010 to one another. Other means and/or mechanisms may be used for coupling the breeder box body 1006, support frame 1008 and/or door 1010 to one another besides the use of mechanical fasteners including, but not limited to, adhesives, welding, and the like.

Although not shown, the front 1104 of the breeder box body 1006 may also include an access door to permit access to the interior 1110 thereof. Other means may be utilized to allow a user, such as a pet owner, to access the interior of the breeder box assembly 802.

In some embodiments, the breeder box assembly 802 may be coupled to the second side panel or to any panel of the first or second enclosures. In several embodiments, there may be multiple breeder box assemblies 802 coupled to the one or more enclosures. For example, there may be a first breeder box assembly 802 coupled to the first enclosure 106 and a second breeder box assembly 802 coupled to the second enclosure 108.

While exemplary embodiments incorporating the principles of the present disclosure have been disclosed hereinabove, the present disclosure is not limited to the disclosed embodiments. Instead, this application is intended to cover any variations, uses, or adaptations of the present disclosure using its general principles. Further, this application is intended to cover such departures from the present disclosure as come within known or customary practice in the art to which this disclosure pertains and which fall within the limits of the appended claims.

1. An animal enclosure, comprising:
a plurality of members defining an interior of the enclosure, wherein the plurality of members comprises a first member having a plurality of interconnected horizontal and vertical wires that define a first opening configured to provide access to the interior;
a support frame comprising a top member, a bottom member, a first side member, and a second side member, the support frame defining a second opening between the top member and the bottom member; and
a box assembly comprising a top, a bottom, a front, a first side, and a second side, the box assembly defining a third opening for accessing an interior thereof;
wherein, the first member, the support frame, and the box assembly are coupled to one another;
wherein, the first opening, the second opening, and the third opening are aligned with one another for coupling the interior of the enclosure with the interior of the box assembly.

2. The animal enclosure of claim 1, wherein a back of the box assembly is entirely open.

3. The animal enclosure of claim 1, wherein the box assembly is formed by a plurality of interconnecting wires.

4. The animal enclosure of claim 1, wherein the box assembly comprises an elongate wire for coupling the top and front to one another.

5. The animal enclosure of claim 4, wherein the elongate wire is removably coupled to the top and front;
wherein, upon removing the elongate wire from coupling the top and front, the box assembly is reconfigurable from an upright configuration to a collapsed configuration.

6. The animal enclosure of claim 1, wherein the support frame is positioned between the first member and the box assembly.

7. The animal enclosure of claim 1, wherein the support frame comprises a first intermediate member and a second intermediate member, wherein the first intermediate member and second intermediate member are coupled between the top member and bottom member.

8. The animal enclosure of claim 7, wherein the first intermediate member and second intermediate member are spaced inwardly from the first side member and second side member, respectively.

9. The animal enclosure of claim 7, wherein the second opening is defined by the top member, bottom member, the first intermediate member and the second intermediate member.

10. The animal enclosure of claim 7, wherein the support frame comprises a first width and the box assembly comprises a second width, the first width being greater than the second width.

11. The animal enclosure of claim 1, wherein the box assembly comprises a first door and a second door, the first door configured to provide direct access to the interior of the box assembly.

12. The animal enclosure of claim 11, wherein the second door defines a fourth opening;
wherein, the fourth opening is aligned with the first opening, second opening and third opening.

13. The animal enclosure of claim 12, wherein the fourth opening is smaller than the first opening, second opening and third opening.

14. The animal enclosure of claim 11, wherein the first side of the box assembly comprises a first cutout portion and a second cutout portion;
wherein, the top member of the support frame is positioned within the first cutout portion and the bottom member thereof is positioned within the second cutout portion.

15. The animal enclosure of claim 14, wherein the first cutout portion is formed between the first side and the top, and the second cutout portion is formed between the first side and the bottom.

16. The animal enclosure of claim 14, wherein the second side of the box assembly comprises a third cutout portion and a fourth cutout portion, the third cutout portion being formed between the second side and the top, and the fourth cutout portion being formed between the second side and the bottom.

17. The animal enclosure of claim 16, wherein the top member of the support frame is positioned within the first and third cutout portions, and the bottom member is positioned within the second and fourth cutout portions.

18. The animal enclosure of claim 11, wherein the first door is pivotally coupled to the top.

19. A multi-level animal enclosure, comprising:
a first enclosure comprising a plurality of members defining an interior of the first enclosure, wherein the plurality of members comprises a first member having a plurality of interconnected horizontal and vertical wires that define a first opening configured to provide access to the interior;
a second enclosure comprising a plurality of members defining an interior of the second enclosure, the second enclosure configured to being located above or below the first enclosure;
a support frame comprising a top member, a bottom member, a first side member, and a second side member, the support frame defining a second opening between the top member and the bottom member; and
a box assembly comprising a top, a bottom, a front, a first side, and a second side, the box assembly defining a third opening for accessing an interior thereof;
wherein, the first member, the support frame, and the box assembly are coupled to one another;
wherein, the first opening, the second opening, and the third opening are aligned with one another for coupling the interior of the enclosure with the interior of the box assembly.

20. A portable animal enclosure, comprising:
a frame comprising at least one support leg and a rotatable member coupled thereto;
a plurality of members defining an interior of the first enclosure, wherein the plurality of members comprises a first member having a plurality of interconnected horizontal and vertical wires that define a first opening configured to provide access to the interior;
a support frame comprising a top member, a bottom member, a first side member, and a second side member, the support frame defining a second opening between the top member and the bottom member; and
a box assembly comprising a top, a bottom, a front, a first side, and a second side, the box assembly defining a third opening for accessing an interior thereof;
wherein, the first member, the support frame, and the box assembly are coupled to one another;
wherein, the first opening, the second opening, and the third opening are aligned with one another for coupling the interior of the enclosure with the interior of the box assembly.
